(19) United States
(12) Patent Application Publication
(10) Pub. No.: US 2024/0071405 A1
(43) Pub. Date: Feb. 29, 2024

(54) DETECTION AND MITIGATION OF LOUDNESS FOR A PARTICIPANT ON A CALL

(71) Applicant: Avaya Management L.P., Durham, NC (US)

(72) Inventors: Rupali Sonawane, Pune (IN); Divyarajsinh Jadeja, Pune (IN); Vipul Sabale, Pune (IN); Harsh V. Mendiratta, East Brunswick, NJ (US)

(21) Appl. No.: 17/895,049

(22) Filed: Aug. 24, 2022

(51) Int. Cl. G10L 21/034; G10L 25/63; H04R 1/08; H04R 29/00

(52) U.S. Cl. CPC G10L 21/034; G10L 25/63; H04R 1/08; H04R 29/008

(57) ABSTRACT

Office noise is common. However, a particular individual may be unaware of the impact their volume of speech is having on others within the same work environment. A user of a communication device may be conducting a call and speaking with sufficient volume to be problematic for others. Accordingly, sound levels are monitored by dedicated and/or otherwise unused sound meters (e.g., microphones) and when a user is speaking sufficiently loudly, a mitigation action is taken to reduce the noise level to a more acceptable level.

### FIELD OF THE DISCLOSURE

The invention relates generally to systems and methods for sound management and particularly to detecting and mitigating excessive noise in a shared work environment.

### BACKGROUND

In open offices a person talking loudly on their call is disturbing to people working around them. Audio levels can be adjusted by people present on the call, but there is no way to notify a participant who is talking excessively loudly and may be unaware they are doing so. A person on a call may routinely talk excessively loudly or may talk excessively loudly sporadically, such as only when certain calls cause the person to be talking excessively loudly. It is often distracting and socially awkward to tell someone they are talking too loudly. They may not believe it and assume the person telling them is overly sensitive or it may interrupt, and potentially derail, an important call.

### SUMMARY

Conferencing and call center applications may utilize the embodiments herein to capture the volume level of a speaking participant of a call to determine if the volume is excessive as observed by those nearby and not participating on the call. Audio and/or audio attributes (e.g., sound amplitude, frequencies, etc.) may be captured after any noise cancellation measures, such as to better determine the actual sound perceived by those nearby. If the participant's speech is too loud, a notification or alert is presented to the participant indicating that their speech is excessively loud and/or to speak at a preferred, lower volume. For example, on audio-only calls a “whisper” alert may be provided to the speaker as a tone or generated message. Calls with a visual component (e.g., calls utilizing a computer or similar device having a visual display as an endpoint for the call) may present a visual cue to the participant to reduce their volume.

In another embodiment, a server monitors the speech and triggers the notification presented to the participant. In another embodiment, a software application residing on the client device utilized by the participant may trigger the notification. Sound levels may be measured from one or more devices and the sound or sound attribute (e.g., volume/amplitude) may be provided to the server and/or client application and, if excessive, trigger the presentation of the alert. The sound may be captured from a centralized device, such as a unidirectional microphone located in an area with the participant and personnel subject to the participant's speech while on a call. The centralized device may provide feedback to a number of individuals regarding their volume of speech while engaged on a call. Other microphone or sound-level sensing devices may be a personal device, microphone of a device utilized by the other individuals for their own calls, and/or other devices.

There may be a number of reasons why a participant is talking excessively loudly on a call. They may be conditioned to talk loudly when on call, they may be stressed (e.g., elevated heart rate, respiration, etc.) and not realize they are talking loudly, rushed, etc. A participant's speaking volume on a call may be correlated with other systems, etc., active or passive biometric monitoring, calendar events (e.g., a recurring call), a prompt or other need to hurry a call such as when more time is needed to property resolve and close the call, a topic discussed on the call, something said during the call, etc.

Feedback to the participant on the call is variously embodied. In one embodiment, feedback (e.g., a tone, visual alert, etc.) occurs in real-time or near real time (e.g., within a few seconds after the participant's speech became louder than a previously determined threshold and/or did not drop below the threshold, etc.). In other embodiments, feedback may occur in non-real time, such as an end-of-day report.

Exemplary aspects are directed to:

A system for managing ambient noise levels, comprising: a sound level meter; a network interface to a communication component; a microprocessor coupled with a computer memory comprising computer readable instructions; wherein the microprocessor performs: receiving an ambient noise level from the sound level meter; determining that the ambient noise level is excessive upon determining that the ambient noise level is above a previously determined threshold and further determining, from the communication component, that a first communication device is concurrently receiving speech from a first user thereof while the first communication device is engaged in a call; and upon determining the ambient noise level is excessive, signaling the first communication device to activate an excessive volume mitigation function.

A method for managing ambient noise levels, comprising: receiving an ambient noise level from a sound level meter; determining that the ambient noise level is excessive upon determining that the ambient noise level is above a previously determined threshold and further determining, from a communication component, that a first communication device is concurrently receiving speech from a first user thereof while the first communication device is engaged in a call; and upon determining the ambient noise level is excessive, signaling the first communication device to activate an excessive volume mitigation function.

A system, comprising: means to receive an ambient noise level from a sound level meter; means to determine whether the ambient noise level is excessive upon determining that the ambient noise level is above a previously determined threshold and, when true, further determining, from a communication component, that a first communication device is concurrently receiving speech from a first user thereof while the first communication device is engaged in a call; and means to, upon determining the ambient noise level is excessive, signal the first communication device to activate an excessive volume mitigation function.

A system on a chip (SoC) including any one or more of the above aspects or aspects of the embodiments described herein.

One or more means for performing any one or more of the above aspects or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The term “volume” as used herein refers to loudness, such as level of sound energy, amplitude of sound waves in air, etc., unless explicitly noted otherwise.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system in accordance with embodiments of the present disclosure;

FIG. 3 depicts a system in accordance with embodiments of the present disclosure;

FIG. 4 depicts a work environment in accordance with embodiments of the present disclosure;

FIG. 5 depicts an ambient noise graph in accordance with embodiments of the present disclosure;

FIG. 6 depicts a process in accordance with embodiments of the present disclosure; and

FIG. 7 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

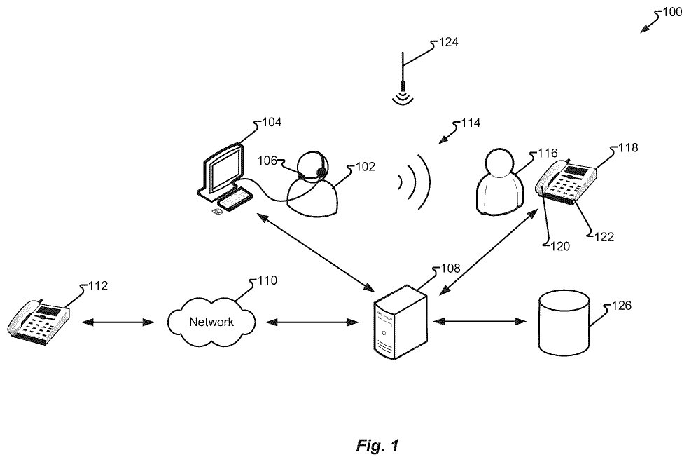

FIG. 1 depicts system 100 in accordance with embodiments of the present disclosure. In one embodiment, system 100 enables encoded voice signals (“call”) to be transmitted between endpoints (e.g., communication device 104 and communication endpoint 112) on network 110 utilized by a participant (e.g., user 102) for sending and receiving speech encoded/decoded for transmission on network 110. Herein, a call comprises, at least, speech provided by user 102. Additional speech may be provided by other users and the call may comprise non-audio communications (e.g., video).

In one embodiment, a call is underway and user 102 utilizes communication device 104 comprising microphone 106 to capture speech and encode the speech into analog and/or digital signals for transmission to communication endpoint 112. Communication component 108 is embodied to monitor the call and determine at least one of the timing of when user 102 is speaking as a portion of the call, the volume (i.e., wave amplitude, sound energy level) of the speech provided to the call, frequency-adjusted volume of the speech (e.g., humans perceive some frequencies as louder than other frequencies having the same sound energy), and/or indicia for one or more of the foregoing (e.g., values for decibels, frequencies, start-stop times, durations, etc.). Additionally or alternatively, communication component 108 is embodied to include functionality of a communication connection component, such as a server, switch, router, gateway, firewall, hub, and/or other communication component utilized to connect communication device 104 to network 110 to communicate with communication endpoint 112. In another embodiment, communication component 108 is co-embodied with communication device 104 and/or communication device 118.

When the call is ongoing, user 102 provides speech to microphone 106 in the form of sound 114. However, sound 114 travels beyond microphone 106, such as to neighbor 116, who is present in the same work environment as user 102. When the volume of sound 114 is excessive, neighbor 116 may be impaired in their ability to perform their own work tasks, such as those requiring concentration or an ability to conduct their own call and be able to hear and comprehend the other party on their call.

Sound 114 may be excessive when speech provided by user 102 is at a volume above what is necessary for their call or above a previously determined threshold. The threshold may be objectively determined (e.g., a decibel level beyond that which microphone 106 and/or communication device 104 can accurately encode sound 114 for conveyance to communication endpoint 112, sound 114 is above the average sound level produced by others located within the work environment) and/or subjectively determined (e.g., neighbor 116 is particularly sensitive to sound 114). Additionally or alternatively, the threshold may also be a function of the distance between user 102 and neighbor 116, whether user 102 is facing towards or away from neighbor 116, acoustics of the work environment, other ambient noises, etc.

In another embodiment, communication device 104 receives a signal indicating that user 102 is speaking at an excessive volume and, in response, energizes an excessive volume mitigation function. For example, communication component 108 may determine that the volume of speech is beyond what is necessary to conduct the call and, therefore, user 102 is talking excessively loudly. Accordingly, communication component 108 signals communication device 104 to activate an excessive volume mitigation function to alert user 102 to their excessive volume of speech. The indicator may be a textual or symbolic message presented on a display, audible message or tone presented only to a speaker utilized by user 102 (e.g., a “whisper” message/tone), haptic feedback, and/or other circuitry and/or logic. Additionally or alternatively, communication device 104 may energize an excessive volume mitigation function to reduce the level of sound presented to communication endpoint 112 and/or add or increase the volume of the speech provided by user 102 back to user 102, such as to allow user 102 to hear their own voice louder and, hopefully, reduce their volume of speech accordingly.

In another embodiment, the volume of speech of sound 114 may be determined by one or more sound level meters operable to receive sound 114 and determine therefrom the volume of speech and/or whether the volume of speech is excessive. Sound level meters may be embodied as decibel meter, dosimeter, and/or microphone. A work environment may have a dedicated sound level meter utilized for measuring ambient sound, such as room microphone 124 which may be further embodied as one or more unidirectional microphones. Additionally or alternatively, a work environment may have a number of other microphones that may be utilized to measure sound 114. For example, communication device 118 may be a communication device allocated to neighbor 116 and comprise handset microphone 120 and/or speaker phone microphone 122, which may receive sound 114 (whether or not neighbor 116 is concurrently utilizing communication device 118 for their own call). Other microphones include microphones of communication device 104 that are different from microphone 106 used to receive sound for the call itself. For example, communication device 104 may comprise a camera with integrated microphone and communication device 104, when embodied as a telephone, may utilize one microphone (e.g., handset microphone, headset microphone, speakerphone microphone) for the call and another microphone for measuring the volume of speech as a portion of ambient noise.

The reasons why user 102 may speak excessively loudly are variously embodied. For example, user 102 may be stressed and (knowingly or unknowingly) talking louder in response to the stress. Data storage 126 may maintain activities for user 102, such as calendar appointments, call logs, transcriptions/recordings of calls, etc. If user 102 only occasionally speaks excessively loudly, the reason may be determined by examining a record of data storage 126. For example, a recording of a call during which user 102 spoke unusually loudly may reveal that user 102 needed more time or was dealing with a particularly difficult customer or work task. As a result, user 102 may be identified as requiring additional training and/or system 100 may be reconfigured to route future calls of a similar stressful nature to other users.

In another embodiment, user 102 may speak at a level that would be considered to be excessively loud, but justified. For example, data storage 126 may comprise a record having attributes of a party utilizing communication endpoint 112 during a call. If the record indicates that party is hard of hearing, then user 102 may be talking loudly in order to be properly heard. Similarly, if communication component 108 determines that the call comprises indicia of inadequate volume of speech from user 102 (e.g., “I can't hear you,” “talk louder,” or a high level of background noise coming from communication endpoint 112), the high volume of speech may be necessary and, in response, any mitigating or notification action may be terminated or omitted. Similarly, if user 102 begins talking excessively loudly but the content of the call indicates a need to do so (e.g., “Now I can hear you,” coming from communication endpoint 112), the mitigating or notification action may similarly be terminated or omitted.

In another embodiment, data storage 126 may comprise a record of sound volumes provided by user 102. Excessive volume indicator function may comprise non-real-time feedback, such as report of times that user 102 spoke excessively loudly and/or situations coinciding with such incidents (e.g., discussing a particular topic, conducting a recurring meeting with a particular individual, etc.).

In order to avoid false positives, the threshold level of volume of speech that is considered excessive may be dependent on duration. User 102 may be saying a particular word or phrase that is difficult to be understood and, once user 102 says the word loudly, the threshold returns to a below-threshold level of speech. Accordingly, any mitigation or notification action may be delayed until the level of speech is above-threshold for a previously determined duration, such as a duration that indicates a general level of speech for the entirety of a call. Additionally or alternatively, any time communication device 104 is not engaged on a call or engaged in a call but communication device 104 or microphone 106 is muted, user 102 may be attending other activities (e.g., speaking in-person to a co-worker, coughing, etc.) and excessive volume indicator function is suspended.

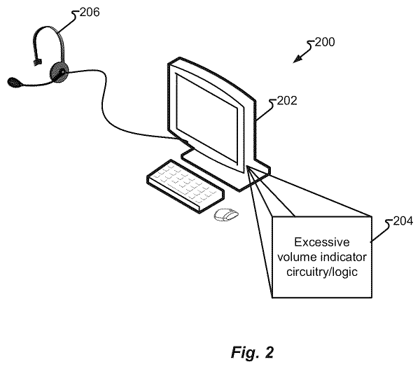

FIG. 2 depicts system 200 in accordance with embodiments of the present disclosure. Communication devices utilized for a call are variously embodied and include, without limitation, analog telephones, digital telephones, wireless (e.g., Wi-Fi, base station radio connection) telephones, cellular telephones, and computers comprising a network interface to a communication network (e.g., network 110) and an application (e.g., soft phone) for engaging in calls. For example, communication device 202 utilizes headset 206 having a microphone and speaker to receive and generate sound. Communication device 202 further comprises excessive volume mitigation circuitry/logic 204.

In one embodiment, excessive volume mitigation circuitry/logic 204, upon receiving a signal indicating that speech provided to a microphone of headset 206 is excessive, is energized. Excessive volume mitigation circuitry/logic 204 may comprise an indicator light circuitry, sound generation circuitry, message display circuitry, etc. Additionally or alternatively, excessive volume mitigation circuitry/logic 204 may comprise automatic sound level controls, such as to avoid providing excessive volume of speech to a call and/or to provide speech received by a microphone of headset 206 to a speaker of headset 206 so as to allow the user to hear themselves as talking loudly.

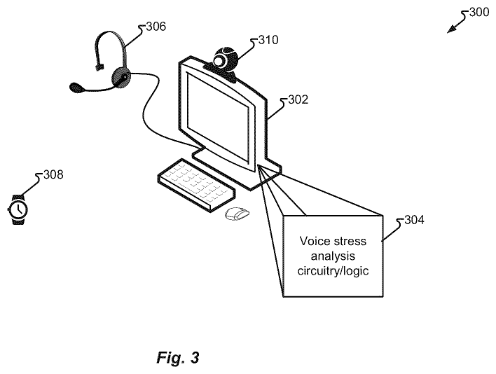

FIG. 3 depicts system 300 in accordance with embodiments of the present disclosure. As introduced above, the reason for a user (e.g., user 102) talking loudly may be a physiological response to stress. In order to determine whether stress is a factor, the user may be monitored, such as by camera 310, biometric sensing wearable device 308 (e.g., smart watch), and/or voice stress analysis circuitry/logic 304. Monitoring may determine if heart rate, perspiration, body temperature, respiration, voice-stress, and/or other stress-indicating attribute is present or has increased at a time coinciding with excessive speaking volume.

Voice stress analysis circuitry/logic 304 may determine if stress is present and/or above a previously determined threshold or average value for a user. In another embodiment, voice stress analysis circuitry/logic 304 may initiate a response to stress and, therefore, promote a decrease in speaking volume of the user during a current stress-inducing call or a subsequent call having similar stress-inducing attributes. Simply making a user aware of their elevated stress level may promote a decease in stress responses, such as decreasing speaking volume. Accordingly, embodiments herein include voice stress analysis circuitry/logic 304 energizing circuitry of a visual (textual, symbolic, etc.), audible (message, tone), haptic, and/or other signal component to alert the user of their current stressful state. In another embodiment, voice stress analysis circuitry/logic 304 may signal a routing component, such as to cause the next call to be a call known to be low stress, provide a break after the call, play soothing music or audible messages via a speaker of headset 306, present soothing messages or imagery on communication device 302, and/or other stress-reducing response. In a further embodiment, the success or absence thereof to reduce the volume of speaking after voice stress analysis circuitry/logic 304 energized a stress-reducing feature, for the user or one or more other users, may be determined by monitoring equipment (e.g., camera 310, biometric sensing wearable device 308, voice stress determination functionality of communication device 302, etc.). When successful, such actions may be “up voted” and utilized more often and/or sooner and, when not successful, may be “down voted” and utilized less often and/or later.

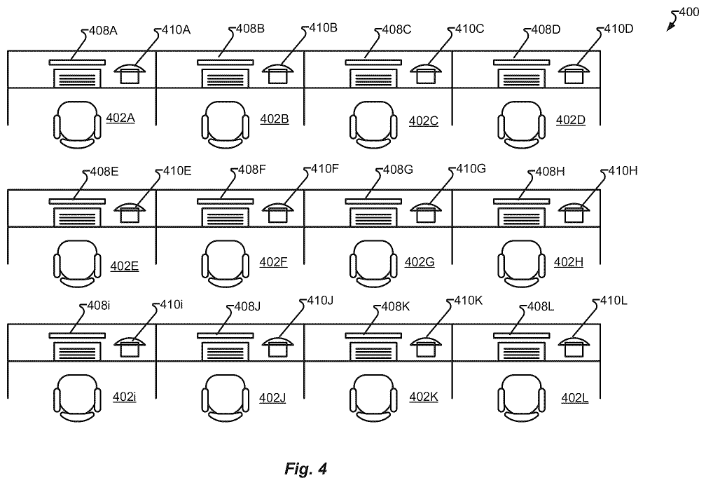

FIG. 4 depicts work environment 400 in accordance with embodiments of the present disclosure. In one embodiment, workstation 402A-L respectively comprise computing device 408A-L and communication device 410A-L. One or both of computing device 408 and communication device 410 may be utilized for conducting a call.

Work environment 400 has an ambient noise level, such as from individuals talking to others via their respective computing device 408 or communication device 410, talking to others in-person, equipment (e.g., climate control, office equipment, etc.), and/or other sources of noise. Ideally, such noise only provides a white-noise originating from an indeterminate source. However, an individual may be talking excessively loudly during a call utilizing computing device 408 and/or communication device 410 to the point where their speech stands out from the other background noise of work environment 400.

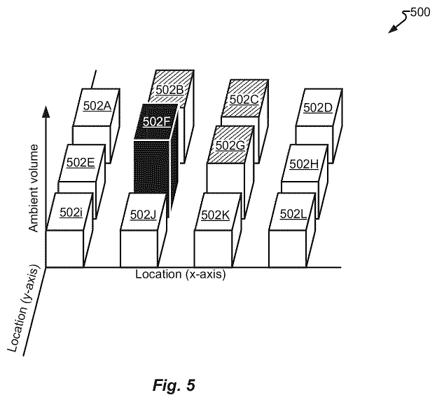

Sound meters may be located at various locations throughout work environment 400. As described above, sound meters may be a dedicated room-monitoring microphone (e.g., room microphone 124), a microphone utilized for other purposes, such as a microphone utilized by computing device 408 or communication device 410 (e.g., handset microphone 120, speaker phone microphone 122, etc.). Once a sound meter determines the sound level to be excessive, the location of the sound levels detected at various locations may be mapped to identify the source (see FIG. 5).

FIG. 5 depicts ambient noise graph 500 in accordance with embodiments of the present disclosure. In one embodiment, ambient noise graph 500 illustrates noise levels 502A-L captured at various locations of a work area, such as work environment 400. In one embodiment, noise levels 502A-L are averaged with the highest individual noise levels (e.g., noise levels 502B, 502C, 502F, and 502G) being emphasized for ease of recognition. Accordingly, ambient noise graph 500 may identify a particular location, such as workstation 402F (see FIG. 4) as the source of the excessive noise. As described herein, mitigating actions may then be directed to the source.

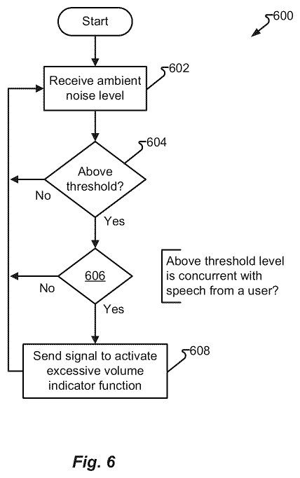

FIG. 6 depicts process 600 in accordance with embodiments of the present disclosure. In one embodiment, process 600 is embodied as machine-readable instructions maintained in a non-transitory memory that when read by a machine, such as a microprocessor of a server, cause the machine to execute the instructions and thereby execute process 600. The microprocessor may be embodied as at least one microprocessor of communication component 108, at least one microprocessor of communication device 104, at least one microprocessor of a discrete device, or combinations thereof wherein processing is portioned between each of the microprocessors.

Step 602 receives an ambient noise level and, at test 604, determines if the ambient noise level is above a previously determined threshold. If test 604 is determined in the negative, then process 600 may loop back to step 602 indefinitely or until interrupted. If test 604 is determined in the affirmative, test 606 then determines if the above-threshold noise level is concurrent with speech from a user. If test 606 is determined in the negative, such as when a user is either not on a call or is on a call but not speaking concurrently with the excessive noise level, then process 600 may loop back to step 602. If test 606 is determined in the affirmative, then step 608 sends a signal to a device to activate an excessive volume mitigation function.

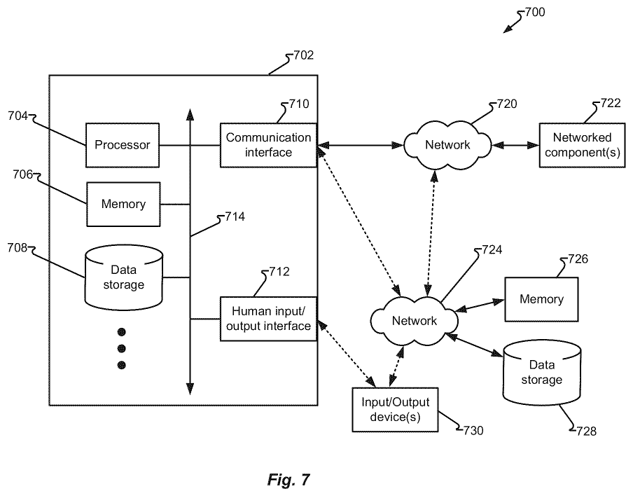

FIG. 7 depicts device 702 in system 700 in accordance with embodiments of the present disclosure. In one embodiment, communication component 108, communication device 104, and/or communication device 118 may be embodied, in whole or in part, as device 702 comprising various components and connections to other components and/or systems. The components are variously embodied and may comprise processor 704. The term “processor,” as used herein, refers exclusively to electronic hardware components comprising electrical circuitry with connections (e.g., pin-outs) to convey encoded electrical signals to and from the electrical circuitry. Processor 704 may comprise programmable logic functionality, such as determined, at least in part, from accessing machine-readable instructions maintained in a non-transitory data storage, which may be embodied as circuitry, on-chip read-only memory, computer memory 706, data storage 708, etc., that cause the processor 704 to perform the steps of the instructions. Processor 704 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 714, executes instructions, and outputs data, again such as via bus 714. In other embodiments, processor 704 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 704 is a non-transitory computing device (e.g., electronic machine comprising circuitry and connections to communicate with other components and devices). Processor 704 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 704). Processor 704 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 704, device 702 may utilize computer memory 706 and/or data storage 708 for the storage of accessible data, such as instructions, values, etc. Communication interface 710 facilitates communication with components, such as processor 704 via bus 714 with components not accessible via bus 714. Communication interface 710 may be embodied as a network port, card, cable, or other configured hardware device. Additionally or alternatively, human input/output interface 712 connects to one or more interface components to receive and/or present information (e.g., instructions, data, values, etc.) to and/or from a human and/or electronic device. Examples of input/output devices 730 that may be connected to input/output interface include, but are not limited to, keyboard, mouse, trackball, printers, displays, sensor, switch, relay, speaker, microphone, still and/or video camera, etc. In another embodiment, communication interface 710 may comprise, or be comprised by, human input/output interface 712. Communication interface 710 may be configured to communicate directly with a networked component or configured to utilize one or more networks, such as network 720 and/or network 724.

Network 110 may be embodied, in whole or in part, as network 720. Network 720 may be a wired network (e.g., Ethernet), wireless (e.g., WiFi, Bluetooth, cellular, etc.) network, or combination thereof and enable device 702 to communicate with networked component(s) 722. In other embodiments, network 720 may be embodied, in whole or in part, as a telephony network (e.g., public switched telephone network (PSTN), private branch exchange (PBX), cellular telephony network, etc.).

Additionally or alternatively, one or more other networks may be utilized. For example, network 724 may represent a second network, which may facilitate communication with components utilized by device 702. For example, network 724 may be an internal network to a business entity or other organization, such as a contact center, whereby components are trusted (or at least more so) than networked components 722, which may be connected to network 720 comprising a public network (e.g., Internet) that may not be as trusted.

Components attached to network 724 may include computer memory 726, data storage 728, input/output device(s) 730, and/or other components that may be accessible to processor 704. For example, computer memory 726 and/or data storage 728 may supplement or supplant computer memory 706 and/or data storage 708 entirely or for a particular task or purpose. As another example, computer memory 726 and/or data storage 728 may be an external data repository (e.g., server farm, array, “cloud,” etc.) and enable device 702, and/or other devices, to access data thereon. Similarly, input/output device(s) 730 may be accessed by processor 704 via human input/output interface 712 and/or via communication interface 710 either directly, via network 724, via network 720 alone (not shown), or via networks 724 and 720. Each of computer memory 706, data storage 708, computer memory 726, data storage 728 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 730 may be a router, a switch, a port, or other communication component such that a particular output of processor 704 enables (or disables) input/output device 730, which may be associated with network 720 and/or network 724, to allow (or disallow) communications between two or more nodes on network 720 and/or network 724. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communication devices, at one or more users' premises, or some combination thereof. Similarly, one or more functional portions of the system could be distributed between a telecommunication device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system for managing ambient noise levels, comprising:
a sound level meter;
a network interface to a communication component; and
a microprocessor coupled with a computer memory comprising computer readable instructions;
wherein the microprocessor performs:
receiving an ambient noise level from the sound level meter;
determining that the ambient noise level is excessive upon determining that the ambient noise level is above a previously determined threshold and further determining, from the communication component, that a first communication device is concurrently receiving speech from a first user thereof while the first communication device is engaged in a call; and
upon determining the ambient noise level is excessive, signaling the first communication device to activate an excessive volume mitigation function.

2. The system of claim 1, wherein the sound level meter comprises a microphone associated with a device that is not utilized for the call.

3. The system of claim 2, wherein the microphone comprises a portion of a second communication device associated with a second user.

4. The system of claim 3, wherein the microphone comprises the portion of the second communication device while concurrently engaged in a communication, discrete from the call, and comprising received speech, via the microphone, from the second user as a portion of the communication.

5. The system of claim 1, wherein the first communication device further comprises a first microphone, utilized to receive speech from the first user for inclusion in the call, and a second microphone comprising the sound level meter and wherein the second microphone is muted with respect to the call.

6. The system of claim 1, wherein the microprocessor further performs, upon receiving from the communication component indica of insufficient volume from a second party engaged in the call with the first user, omitting signaling the first communication device to activate the excessive volume mitigation function.

7. The system of claim 1, further comprising:
a biometric monitoring component configured to monitor at least one physiological attribute of the first user; and
wherein the microprocessor further performs, upon receiving indica of stress from the biometric monitoring component, signaling the first communication device to activate a stress reduction function.

8. The system of claim 1, wherein the first communication device comprises the excessive volume mitigation function, and further comprises at least one of a visual indicator or an audible indicator.

9. The system of claim 1, wherein the first communication device comprises the excessive volume mitigation function and further comprises decreasing the audio level of the speech in the call.

10. The system of claim 1, wherein the first communication device and the communication component are a single device.

11. A method for managing ambient noise levels, comprising:
receiving an ambient noise level from a sound level meter;
determining that the ambient noise level is excessive upon determining that the ambient noise level is above a previously determined threshold and further determining, from a communication component, that a first communication device is concurrently receiving speech from a first user thereof while the first communication device is engaged in a call; and
upon determining the ambient noise level is excessive, signaling the first communication device to activate an excessive volume mitigation function.

12. The method of claim 11, wherein the sound level meter comprises a microphone associated with a device that is not utilized for the call.

13. The method of claim 11, wherein the microphone comprises a portion of a second communication device associated with a second user.

14. The method of claim 13, wherein the microphone comprises the portion of the second communication device while concurrently engaged in a communication, discrete from the call, and comprising received speech, via the microphone, from the second user as a portion of the communication.

15. The method of claim 11, wherein the first communication device further comprises a first microphone, utilized to receive speech from the first user for inclusion in the call, and a second microphone comprising the sound level meter and wherein the second microphone is muted with respect to the call.

16. The method of claim 11, further comprising, upon receiving from the communication component indica of insufficient volume from a second party engaged in the call with the first user, omitting signaling the first communication device to activate the excessive volume mitigation function.

17. The method of claim 11, further comprising:
monitoring at least one physiological attribute of the first user; and
upon receiving indica of stress from a biometric monitoring component, signaling the first communication device to activate a stress reduction function.

18. The method of claim 11, wherein the first communication device comprises the excessive volume mitigation function, further comprising at least one of a visual indicator or an audible indicator.

19. The method of claim 11, wherein the first communication device comprises the excessive volume mitigation function, further comprising decreasing the audio level of the speech in the call.

20. A system, comprising:
means to receive an ambient noise level from a sound level meter;
means to determine whether the ambient noise level is excessive upon determining that the ambient noise level is above a previously determined threshold and, when true, further determining, from a communication component, that a first communication device is concurrently receiving speech from a first user thereof while the first communication device is engaged in a call; and
means to, upon determining the ambient noise level is excessive, signal the first communication device to activate an excessive volume mitigation function.
